(19) United States
(12) Patent Application Publication
(10) Pub. No.: US 2011/0253953 A1
(43) Pub. Date: Oct. 20, 2011

(54) RACK AND PINION MECHANISM, VACUUM PROCESSING APPARATUS, METHOD OF DRIVING AND CONTROLLING RACK AND PINION MECHANISM, DRIVE CONTROL PROGRAM, AND RECORDING MEDIUM

(75) Inventor: Yasutomo Tanaka, Kawasaki-shi (JP)

(73) Assignee: CANON ANELVA CORPORATION, Kawasaki-shi (JP)

(21) Appl. No.: 13/133,228

(22) PCT Filed: Dec. 9, 2009
(86) PCT No.: PCT/JP2009/006716

§ 371 Date: Jul. 7, 2011

(30) Foreign Application Priority Data
Dec. 9, 2008 (JP) 2008313139
Dec. 9, 2008 (JP) 2008313147

(51) Int. Cl. B66F 3/02; F16H 35/06

(52) U.S. Cl. 254/95; 74/395

(57) ABSTRACT

The present invention provides a rack and pinion mechanism which avoids collision between respective tooth tops of a rack gear and a pinion gear due to a phase shift between the rack gear and the pinion gear with a simple mechanism and meshes the rack gear and the pinion gear smoothly.

The rack and pinion mechanism includes a rack gear 16 fixed to a stage 20 moving on a carrying track 7 while loading a carried object thereon and a plurality of pinion gears 17 connected to a drive source 13. At least two of the pinion gears are synchronized and rotate to mesh with the rack gear in sequence, whereby the rack gear is delivered from the pinion gear in the current process to the pinion gear in the subsequent process, so that the stage is carried. The rack and pinion mechanism includes detection means that detects a phase difference of the pinion gear and a controller 25 which has a storage part 27, storing the detected phase difference, and controls the phase difference of the pinion gear in the subsequent process based on the phase difference of the pinion gear in the current process.

### TECHNICAL FIELD

The present invention relates to a rack and pinion mechanism as a carrying mechanism, a vacuum processing apparatus comprising the rack and pinion mechanism, a method of driving and controlling a rack and pinion mechanism, a drive control program, and a recording medium recorded with the drive control program.

### BACKGROUND ART

A rack and pinion is constituted of a combination of a pinion gear and a rack gear in which one surface of a rectangular bar member is toothed in the width direction and is a mechanism which converts a rotating operation of the pinion gear to a linear operation of the rack gear. The rack and pinion mechanism is utilized as a steering mechanism of a bicycle, a carrying mechanism, and so on.

For example, in a vacuum processing apparatus such as an in-line sputtering apparatus, a substrate tray holding a substrate is carried in sequence by a carrier with rack to be delivered between respective vacuum chambers, and the substrate is subjected to a desired treatment. Specifically, in the carrying of the substrate tray, a rack gear is fixed to the substrate tray to be meshed with a pinion gear in each vacuum chamber, and, thus, to be rotated and driven, whereby the substrate tray is delivered in sequence to a pinion in the vacuum chamber in the subsequent process.

However, when the substrate tray is delivered from the pinion gear in the current process to the pinion gear in the subsequent process, the tooth top of the rack gear, which will be meshed with the pinion gear, and the tooth top of the pinion gear often collide with each other. If the respective tooth tops collide with each other, a load is applied to a drive mechanism, leading to damage of the drive mechanism, or the tooth of the rack gear lifts on the tooth of the pinion gear, so that carrying may be disabled. Alternatively, the collision occurring when the meshing between the rack gear and the pinion gear returns to normal meshing may lead to product failure due to damage of the substrate and generation of dust.

Thus, in order to solve the above problems, a technique of providing a one-way clutch and a technique of making the pinion gear escape in a direction vertical to a pinion shaft or in an axial direction have been proposed. Those techniques are invented on the idea that even if the tooth tops collide with each other, the collision is immediately automatically returned to normal meshing.

Further, there has been proposed a technique of correctly managing a stopping angle of the pinion gear by a sensor and a control mechanism and engaging the rack gear and the pinion gear without collision of the tooth top of the rack gear with the tooth top of the pinion gear.

In addition, there has been proposed a rack and pinion mechanism which previously matches a phase of the pinion gear to the rack gear by mechanical means (for example, see Patent Document 1). Specifically, in the mechanism, a sphere member is supported by a spring to be pressed against a recess of a cam, and, thus, to be brought into contact with the recess. Then, a stopping angle of a pinion shaft is set to a predetermined position, and a phase of a pinion guide is matched to a phase of a rack guide before the pinion gear and the rack gear mesh with each other. According to this constitution, the rack gear and the pinion gear can be meshed with each other without causing the collision between the respective tooth tops.

Further, there has been proposed a carrying device comprising a plurality of stepping motor driven pinion gears provided in a longitudinal direction and synchronized drive means. The pinion gears are disposed so that at least one of the pinion gears meshes with a rack gear. The synchronized drive means synchronously drives at least every two pinion gears (for example, see Patent Document 2).

### PRIOR ART DOCUMENTS

### Patent Documents

Patent Document 1: Japanese Patent Application Laid-Open No. 8-74961
Patent Document 2: Japanese Patent Application Laid-Open No. 9-29130

### SUMMARY OF THE INVENTION

### Problems to be Solved by the Invention

In the conventional technique of providing the one-way clutch and the conventional technique of escaping the pinion gear, the phase relationship between the rack gear and the pinion gear is not modified initially, and the meshing is to be returned to the normal meshing after that. Accordingly, the collision between the rack gear and the pinion gear cannot be avoided in the first place, and the tooth tops may be damaged.

When the clutch is provided, a direction of the motion of the rack gear is limited to one direction. In the technique of escaping the pinion gear, an intermediate gear is required to be provided, so that an installation place increases, and, at the same time, a sliding movement portion increases to lead to complexity of a mechanism.

According to the technique of the Patent Document 1, a stop position of the pinion gear can be managed based on the positional relationship between the sphere member supported by the spring and the cam, and this technique has the advantage that the tooth top of the rack gear and the tooth top of the pinion gear do not collide in principle. However, with regard to the rotation of the pinion gear, when a rotational driving force is transmitted at high speed, the accuracy of a rotation stop angle is restricted by a mechanical structure portion. Accordingly, the pinion gear cannot always be stopped at a fixed position, so that the mechanical structure portion becomes loose, and further friction occurs therein. Therefore, there is a problem that the mechanical structure portion should always be adjusted repeatedly.

The technique of managing the stop position of the pinion gear by the sensor and the control mechanism allows the engagement between the pinion gear and the rack gear after the complete coincidence of the phases of the pinion gear and the rack gear. Therefore, it is considered that such a phenomenon does not occur in principle. However, especially when the technique is to be applied to a vacuum processing apparatus, a high temperature processing is performed at up to approximately 400° C. in the vacuum processing apparatus, so that the influence of heat from a sensor and so on and heat expansion of the rack gear are required to be considered.

According to the technique of the Patent Document 2, at least every two pinion gears are synchronously driven by the synchronized drive means, and control is performed so that synchronism is performed before the rack gear meshes with the pinion gear in the subsequent process. However, the teeth of the pinion gear may butt against the teeth of the rack gear. If the teeth of the pinion butt against the teeth of the rack gear, the torque value of a motor increases to cause an overload error or to damage the teeth, so that carrying cannot be continued.

The first object of the present invention is to provide a rack and pinion mechanism, which can avoid collision between respective tooth tops of a rack gear and a pinion gear due to a phase shift between the rack gear and the pinion gear with a simple mechanism and can smoothly mesh the rack gear with the pinion gear, and a vacuum processing apparatus comprising the rack and pinion mechanism.

The second object of the present invention is to provide a rack and pinion mechanism, which does not require a complex mechanism and adjusts by itself a mesh relationship between a rack gear and a pinion gear, meshing with the rack gear, during carrying of a substrate and thus can continue a stable carrying, and a vacuum processing apparatus comprising the rack and pinion mechanism.

The present invention further provides a method of driving and controlling a rack and pinion mechanism that can achieve the above objects, a drive control program, and a recording medium.

### Means for Solving the Problems

In order to achieve the above objects, the present invention is constituted as follows.

Namely, a rack and pinion mechanism according to a first aspect of the invention comprises a rack gear, which is fixed to a stage moving on a carrying track while loading a carried object thereon, and a plurality of pinion gears which are connected to a drive source and mesh with the rack gear. In the rack and pinion mechanism, at least two of the pinion gears are synchronized and rotated to mesh with the rack gear in sequence, so that the rack gear is delivered from the pinion gear in the current process to the pinion gear in the subsequent process, whereby the stage is carried. The rack and pinion mechanism includes detection means that detects a phase difference of the pinion gear and a controller which has a storage part, storing the phase difference of the pinion gear detected by the detection means, and controls the phase difference of the pinion gear in the subsequent process based on the phase difference of the pinion gear in the current process.

A rack and pinion mechanism according to a second aspect of the invention includes a rack gear, which is fixed to a stage moving on a carrying track while loading a carried object thereon, a plurality of pinion gears which are connected to a drive source and mesh with the rack gear to move the stage, detection means that detects a phase difference of the pinion gear, and a controller which has a storage part storing a phase angle of the pinion gear detected by the detection means. The rack and pinion mechanism is characterized as follows. Namely, the controller controls the drive source during carrying of the stage, rotates the pinion gear, meshing with the rack gear, in one direction at a lower speed than a set carrying speed. When the torque value of the drive source is not less than a designated torque, the controller stores a first phase angle of the pinion gear rotated in the one direction that is detected by the detection means. The pinion gear is rotated in the opposite direction to the one direction at the above low speed, and when the torque value of the drive source is not less than a designated torque, the controller stores a second phase angle of the pinion gear rotated in the opposite direction that is detected by the detection means. The controller calculates the half angle of a rotational angle ranging from the first phase angle to the second phase angle and rotates the pinion gear to the half angle.

### Effect of the Invention

According to the present invention, the collision between the respective tooth tops of the rack gear and the pinion gear due to the phase shift between the rack gear and the pinion gear can be avoided with a simple mechanism, and the rack gear and the pinion gear can be smoothly meshed with each other.

Further, a complex mechanism is not required, and during carrying of a substrate, the mesh relationship between the rack gear and the pinion gear meshing with the rack gear is adjusted by itself, whereby a stable carrying can be continued.

According to the above constitution, the reliability of a long continuous operation of the rack and pinion mechanism can be improved.

### BRIEF DESCRIPTION OF THE DRAWINGS

FIG. 1A plan view schematically showing an embodiment of a vacuum processing apparatus comprising a plurality of vacuum chambers.

FIG. 2 A side view schematically showing a state that a vacuum processing chamber is viewed from a carrying direction shown by an arrow in FIG. 1.

FIG. 3 A flow chart showing a method of driving and controlling a rack and pinion mechanism of a first embodiment.

FIG. 4 A schematic view showing a mesh relationship between a rack gear and a pinion gear of the first embodiment.

FIG. 5 A flow chart showing a method of driving and controlling a rack and pinion mechanism of a second embodiment.

FIG. 6 A schematic view showing a mesh relationship between a rack gear and a pinion gear of the second embodiment.

FIG. 7 A flow chart showing a method of driving and controlling a rack and pinion mechanism of a third embodiment.

FIG. 8 A schematic view showing a mesh relationship between a rack gear and a pinion gear of the third embodiment.

### MODES FOR CARRYING OUT THE INVENTION

Hereinafter, embodiments of the present invention will be described with reference to the drawings. However, the invention is not limited to the embodiments.

### First Embodiment

### <Vacuum Processing Apparatus>

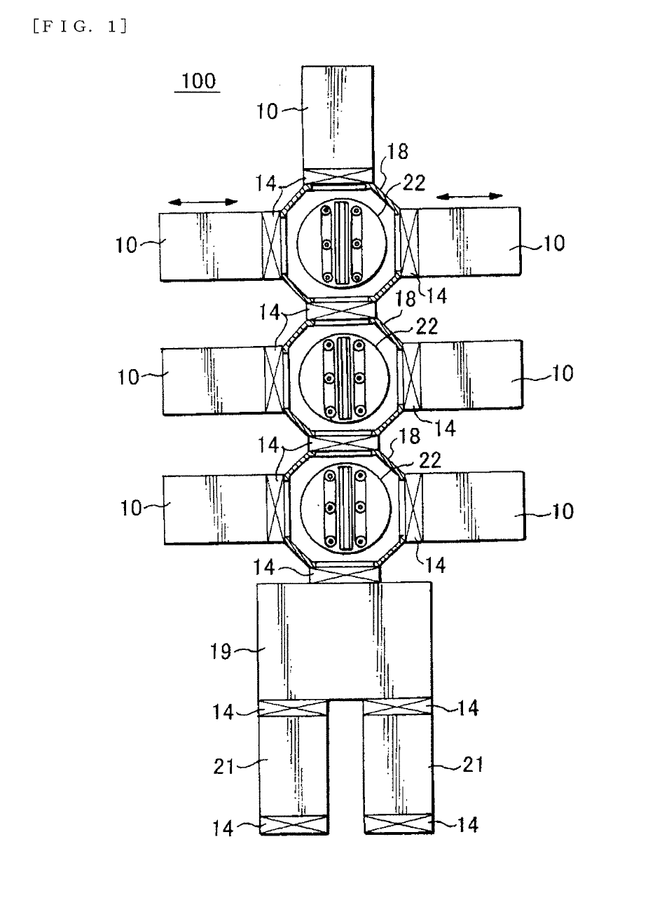

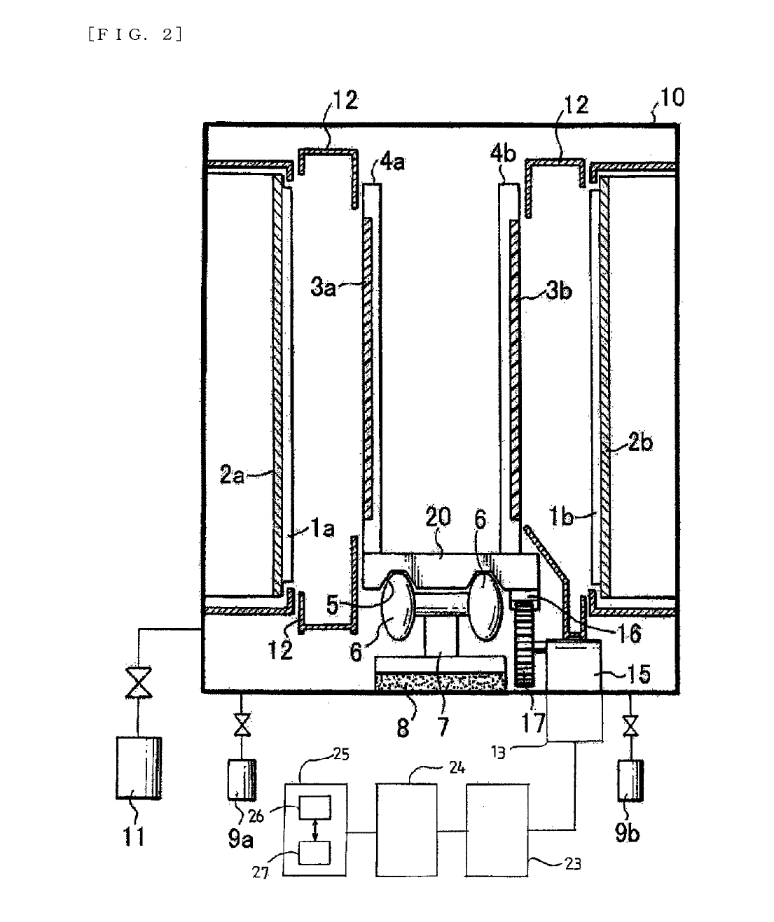

FIG. 1 is a plan view schematically showing an embodiment of a vacuum processing apparatus comprising a plurality of vacuum chambers. FIG. 2 is a side view schematically showing a state that a vacuum processing chamber 10 is viewed from a carrying direction shown by an arrow in FIG. 1.

As shown in FIG. 1, a vacuum processing apparatus 100 of the present embodiment is connected to a plurality of vacuum chambers having various functions through gate valves 14. The vacuum chambers have various functions. Specifically, in the vacuum processing apparatus 100 of the present embodiment, three turnaround chambers 18 are connected in series through the gate valves 14. The turnaround chambers 18 each have a rotating mechanism (turn table) 22 of a carrier (stage) 20 to be described later. The vacuum processing chambers 10 are provided around the respective turnaround chambers 18, and the two or three vacuum processing chambers 10 are connected to the respective turnaround chambers 18 through the gate valves 14. The vacuum processing chamber 10 of the present embodiment is constituted of a sputtering film-formation chamber, for example; however, the vacuum processing chamber 10 is not limited to this constitution, and only heating and cooling may be performed in the vacuum processing chamber 10.

One of the three turnaround chambers 18 is connected to an intermediate chamber 19, which is, for example, a spare chamber, through the gate valve 14. The intermediate chamber 19 stores therein a substrate through the gate vale 14 and, at the same time, is connected to two load lock chambers 21 for taking in and out the substrate between a vacuum space and air. The load lock chambers 21 are partitioned as the vacuum spaces and each have a carrying track 7 and a carrying mechanism to be described later.

The number of the turnaround chambers 18 connected in series through the gate valves 14 and the number of the vacuum processing chambers 10 connected to each of the turnaround chambers 18 through the gate valves 14 are not limited to the number of the present embodiment.

As shown in FIG. 2, the carrying track 7 that specifies the carrying direction is laid on the center of a bottom surface of the vacuum processing chamber (sputtering film-formation chamber) 10. A plurality of bearings 6 as guide members are supported on the carrying track 7 so as to follow the track. The bearings 6 support a carrier 20 and engage with concave support portions 5 provided in the lower surface of the carrier 20. Namely, the carrier 20 moves on the carrying track 7 while being supported and guided by the bearings 6. At that time, the weight of the entire carrier 20 reaches not less than about 200 kg, for example. However, since the carrier 20 is symmetrical to the width direction of the carrying track 7 and has a self-standing structure, the carrier 20 is safely supported by the bearings 6. A vibration-proofing material 8 is interposed under the carrying track 7 and suppresses transmission of vibration to the vacuum processing chamber 10 during carrying of the carrier 20. A carrier carrying mechanism will be described later.

Substrate trays 4a and 4b holding substrates 3a and 3b as carried objects are provided upright on the carrier 20. The substrates 3a and 3b are constituted of, for example, glass substrates and held by the substrate trays 4a and 4b so as to face opposite directions to each other and turn their backs to each other. Ina preparation chamber (not shown), the substrate trays 4a and 4b are inclined to attach the two substrates 3a and 3b to the carrier 20. Although the substrate trays 4a and 4b holding the substrates 3a and 3b are arranged on the both sides of the carrier 20 in FIG. 2, they may be arranged on one side of the carrier 20. The substrates 3a and 3b are held by the carrier 20 through, for example, fixing tools (not shown) attached to respective four sides of the substrate trays 4a and 4b while the substrates 3a and 3b are supported by the four sides.

The substrate trays 4a and 4b may be arranged by being inclined inward at a predetermined angle to a vertical direction so that treated surfaces of the substrates 3a and 3b face obliquely upward. When a length of each one side of the substrates 3a and 3b is not less than approximately 1 m, the inclination angle with respect to the vertical direction is preferably not less than 0.5 degree and not more than 3 degrees. Consequently, the substrates 3a and 3b can be prevented from protruding during carrying of the substrates, and the substrates 3a and 3b can be stably carried at high speed (for example, 500 to 600 mm/sec). The substrate trays 4a and 4b may have an opening (not shown) for heating the substrates 3a and 3b from the back sides.

Each of the vacuum processing chambers 10 is connected to an exhauster 11 for exhausting gas from the vacuum processing chamber 10. The vacuum processing chamber 10 is evacuated at a degree of vacuum of approximately 2×10 Pa to 2×10⁻⁵ Pa by the exhauster 11. Each of the vacuum processing chambers 10 is connected to gas supply devices 9a and 9b which supply a processing gas into the vacuum processing chamber 10.

Targets 1a and 1b are arranged to face the substrates 3a and 3b and supported in a standing state by backing plates 2a and 2b. A magnet unit (not shown) for generating a closed-loop magnetic field on the surfaces of the targets 1a and 1b is provided on the rear sides of the backing plates 2a and 2b. Respective spaces between the substrates 3a and 3b and the targets 1a and 1b are vertically covered by shield members 12.

### <Rack and Pinion Mechanism>

Next, a rack and pinion mechanism as the carrier carrying mechanism will be described with reference to FIG. 2.

As shown in FIG. 2, a linear gear referred to as a rack gear 16 in which one surface of a rectangular bar member is toothed in the width direction is arranged on one side of the lower surface of the carrier 20 along the carrying direction so that a gear portion of the linear gear faces downward. In the present embodiment, although the rack gear 16 is arranged on only one side of the lower surface of the carrier 20, the rack gears 16 may be arranged on the both sides of the lower surface of the carrier 20. The rack gear 16 is meshed with a circular gear referred to as a pinion gear 17. The rack and pinion carrying mechanism is a gear mechanism converting a rotating operation of the pinion gear 17 to a linear operation of the rack gear 16 and corresponds to the carrier carrying mechanism of the present invention.

The pinion gear 17 is provided in each vacuum chamber and rotated by a driving force from a drive source 13 such as a servomotor which is disposed on the air side through a pinion drive device 15 comprising a plurality of intermediate gears. At least two of the pinion gears 17 are synchronized to rotate, and, thus, to mesh with the rack gear 16 in sequence, whereby the rack gear 16 is delivered from the pinion gear 17 in the current process to the pinion gear 17 in the subsequent process.

The servomotor 13 is connected to the pinion gear 17 and the pinion drive device 15 and provided on the air side of each of the vacuum processing chambers 10. The servomotor 13 is electrically connected to a servo amplifier 23 and a motor controller 24. The motor controller 24 controls the servomotor 13. Each of the servomotors 13 has an encoder (not shown) as means for detecting a phase difference (or a phase angle) of the pinion gear 17. Further, the vacuum processing apparatus 100 comprises a controller 25, which controls each of the vacuum processing chambers 10 and so on. The controller 25 is constituted of a personal computer (PC), for example, and comprises a CPU 26 which performs calculation processing and a storage part 27 which stores therein a drive control program, a parameter, and so on.

By virtue of the provision of the rack and pinion mechanism the rack gear 16 meshing with the pinion gear 17 moves in the carrying direction, and accompany the movement, the carrier 20 is moved from, for example, a processing chamber in which preprocessing is performed and then carried to the vacuum processing chamber 10 in the subsequent process.

The carrier 20 having the substrate trays 4a and 4b holding the substrates 3a and 3b stops at a fixed position of the vacuum processing chamber 10. While the carrier 20 stops in front of the targets 1a and 1b, the carrier 20 is sputtered, and film formation is performed. The carrier 20 after completion of predetermined film formation passes through the gate valve 14 to move to the vacuum processing chamber 10 in the subsequent process.

### <Method of Driving and Controlling Rack and Pinion Mechanism>

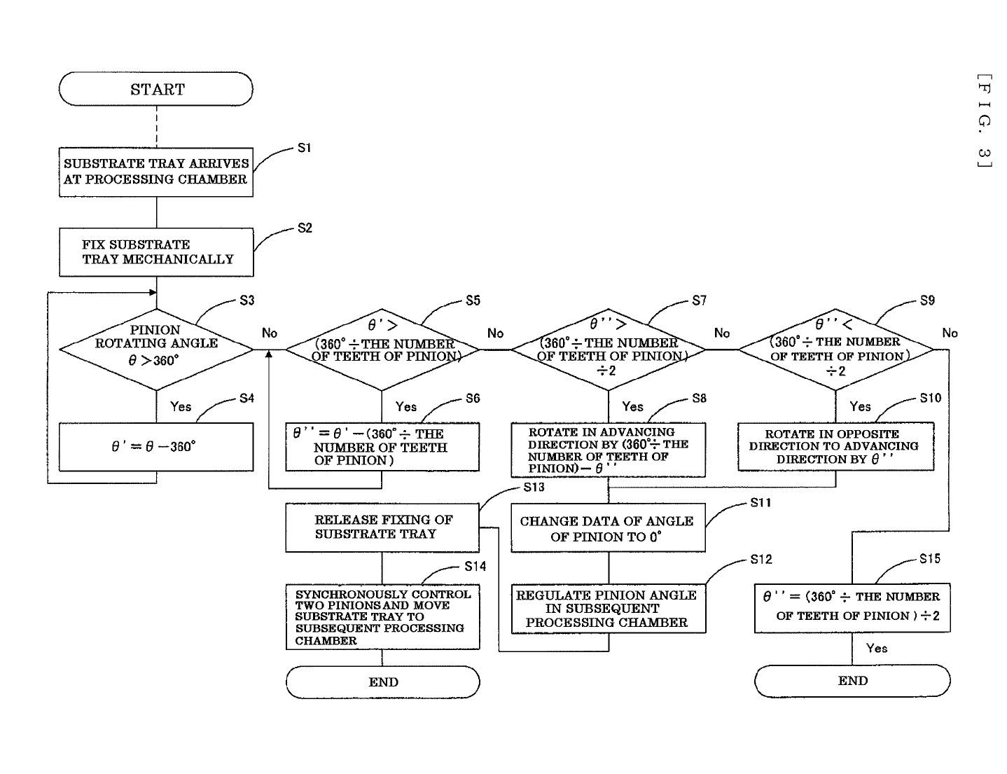

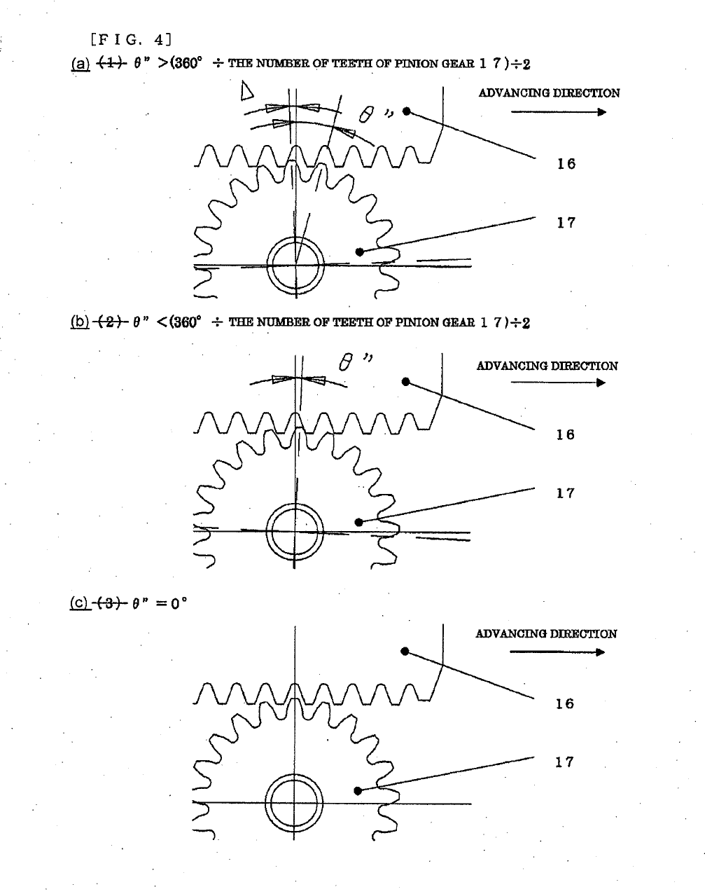

Next, the operation of the rack and pinion mechanism and the method of driving and controlling the rack and pinion mechanism of the first embodiment will be described with reference to FIGS. 3 and 4. FIG. 3 is a flow chart showing the method of driving and controlling the rack and pinion mechanism of the first embodiment. FIG. 4 is a schematic view showing a mesh relationship between the rack gear and the pinion gear of the first embodiment.

An algorithm of the method of driving and controlling the rack and pinion mechanism of the first embodiment is stored as a drive control program in the storage part 27 of the controller 25. The drive control program is read from the CPU 26 at the start of operation and then executed.

The drive control program is a program causing the controller 25 to control the rack and pinion mechanism based on a detection signal of the encoder of the servomotor 13. Specifically, the drive control program of the first embodiment has the following processes. In the first process, a reference point is determined to the pinion gear 17 in the current process, and the reference point is stored. In the second process, the rotating angle that the pinion gear 17 in the current process rotates from the reference point from when the pinion gear 17 starts to mesh with the rack gear 16 till the termination of the meshing is obtained. In the third process, “360 degrees÷the number of teeth of the pinion gear” is a calculated as one teeth number angle of the pinion gear 17 in the current process. In the fourth process, a residual angle is calculated by dividing the rotating angle by the one teeth number angle. In addition, in the fifth process, when the residual angle is more than half of the one teeth number angle, the pinion gear 17 in the subsequent process is rotated from the reference point in the advancing direction by “one teeth number angle−residual angle”. Meanwhile, when the residual angle is less than the half of the one teeth number angle, in the sixth process, the pinion gear 17 in the subsequent process is rotated from the reference point in the opposite direction to the advancing direction by the residual angle. When the residual angle is the same as the half of the one teeth number angle, the control is terminated.

The drive control program is recorded in a PC-readable recording medium and installed in the storage part 27 of the PC. The recording medium includes a magnetic recording medium such as a Floppy™ disk and ZIP™, a magneto-optical recording medium such as MO, and an optical disk such as CD-R, DVD-R, DVD+R, CD-R, DVD-RAM, DVD+RAM™, and PD. The recording medium further includes flash memories such as Compact Flash™, Smart Media™, Memory Stick™, and an SD card and a removable disk such as Micro Drive™, and Jaz™.

In the drive control method according to the present embodiment, the carrier 20 comprising the substrate trays 4a and 4b arrives at the vacuum processing chamber 10 from a preliminary processing chamber. However, in fact, there are a plurality of carriers 20 in the vacuum processing apparatus 100, and the carriers 20 are carried continuously. This point is the same as that in the second and third embodiments to be described later.

Although the angle of the pinion gear 17 will be described below, the drive source of the pinion gear 17 is the servomotor 13 (see, FIG. 2), and therefore, the angle of the pinion gear 17 can be calculated from the value of the encoder of the servomotor 13.

In the drive control method according to the first embodiment, first, when the carrier 20 comprising the substrate trays 4a and 4b arrives at the vacuum processing chamber 10 (step 1: hereinafter referred to as “S1”), the substrate trays 4a and 4b are mechanically fixed, and the position of the rack gear 16 is fixed (S2). While the rack gear 16 is fixed, as shown in FIG. 4C, for example, the center of recesses of the teeth of the rack gear 16 is coincided with the center of protrusions of the teeth of the pinion gear 17, and the mesh relationship in such a state is designated as a reference point where the pinion gear 17 is at 0 degree.

In the carrying of the carrier 20, even when the teeth of the pinion gear 17 exist at the reference point of 0 degree in the initial setting, the rack gear 16 moves while meshing with the pinion gear 17. As a result, the angle of the pinion gear 17 is changed by the moving distance of the rack gear 16, and the teeth of the pinion gear 17 do not always stop at 0 degree.

Thus, when the carrier 20 moves from the current process to the subsequent process, the controller 25 performs a drive control so that the teeth of the pinion gear 17 in the subsequent process to which the rack gear 16 will move always keep the same direction (angle) with respect to the rack gear 16.

In the position fixed state, in order to carry the carrier 20 first, the angle that the pinion gear 17 in the current process rotates from the reference point of 0 degree from when the pinion gear 17 starts to mesh with the rack gear 16 till the termination of the meshing is obtained. The angle (rotating angle) that the pinion gear 17 rotates for the purpose of carrying the carrier 20 is designated as θ. When θ is a multiple of 360 degrees, the pinion gear 17 is in the same state as before rotation, naturally. Accordingly, it is determined whether or not the pinion gear rotating angle θ is more than 360 degrees (S3). When the pinion gear rotating angle θ>360 degrees (S3/Yes), 360 degrees is subtracted from θ (θ−360 degrees), and θ becomes a value of not more than 360 degrees (S4). For convenience's sake of explanation, the value obtained at that time is θ′, and θ−360 degrees is repeated until θ′ is not more than 360 degrees (θ′≦360 degrees). Since 360 degrees is subtracted, the state when the pinion gear 17 rotates to θ degree is the same as the state when the pinion gear 17 rotates to θ′ degree.

Meanwhile, when the pinion gear rotating angle θ≦360 degrees (θ′≦360 degrees) (S3/No), one teeth number angle of the pinion gear 17 is obtained, and it is determined whether or not θ (θ′) is more than the one teeth number angle (S5). Here, “360 degrees÷the number of teeth of the pinion gear” is designated one teeth number angle. When θ′ obtained above is equal to a multiple of one teeth number angle, it is regarded that the pinion gear 17 is in the same state as before rotation. This is because in the mesh relationship between the rack gear 16 and the pinion gear 17, it doesn't matter which of the teeth of the pinion gear 17 meshes with the rack gear 16. Namely, even if the pinion gear 17 rotates by “360 degrees÷the number of teeth of the pinion gear”, the positional relationship between the pinion gear 17 and the rack gear 16 is not changed.

When θ′>“360 degrees÷the number of teeth of the pinion gear” (S5/Yes), θ′−“360 degrees÷the number of teeth of the pinion gear” is repeated until θ′ is not more than one teeth number angle, and θ″≦“360 degrees the number of teeth of the pinion gear” is obtained (S6). In the relationship with the rack gear 16, the state when the direction of the teeth of the pinion gear 17 rotates to θ′ is the same as the state when the direction of the teeth of the pinion gear 17 rotates to θ″. θ″ obtained thus can be regarded as substantially the residual angle (phase difference) obtained when the pinion gear 17 rotates from the initial state (reference point).

Steps S3 to S6 may include a process of obtaining the rotating angle θ of the pinion gear 17, a process of calculating one teeth number angle of the pinion gear 17, and a process of calculating the residual angle θ′ (0″) that is an indivisible angle obtained when the rotating angle θ is divided by one teeth number angle. The residual angle θ′ (θ″) is the phase difference from the reference point.

As shown in FIGS. 4A and 4B, there may occur two states that the teeth of the rack gear 16 and the teeth of the pinion gear 17 do not mesh according to the magnitude of θ″. Specifically, in the first state, as shown in FIG. 4A, the residual angle θ″ is more than half of one teeth number angle (S7/Yes). In the second state, as shown in FIG. 4B, the residual angle θ″ is less than the half of one teeth number angle (S7/No).

In order to shift the first state of FIG. 4A (S7/Yes) to the state of the reference point of FIG. 4C, the pinion gear 17 is rotated in the advancing direction by Δ of one teeth number angle−the residual angle θ″ (S8). This is because even if the pinion gear 17 is to be rotated by θ″ degree in the opposite direction to the advancing direction, the teeth of the pinion gear 17 butt against the teeth of the rack gear 16 to interfere with the mesh relationship.

Meanwhile, in order to shift the second state of FIG. 4B to the state of the reference point of FIG. 4C, the pinion gear 17 may be rotated in the opposite direction to the advancing direction by the residual angle of θ″ degree (S10).

When the pinion gear 17 is controlled as S8 and S10, the positional relationship between the rack gear 16 and the pinion gear 17 is similar to the state of the reference point of FIG. 4C. Therefore, the current angle of the pinion gear 17 managed by the controller 25 is changed to the reference point of 0 degree to be recognized (S11). The angle of the pinion gear 17 in the vacuum processing chamber 10 in the subsequent process is regulated based on the calculating processing (S12), and, at the same time, the fixing of the substrates 4a and 4b is released (S13). Then, the pinion gear 17 in the current process and the pinion gear 17 in the subsequent process are synchronously controlled, and the carrier 20 including the substrates 4a and 4b is moved to the vacuum processing chamber 10 in the subsequent process (S14).

When the residual angle θ″ is the same as the half of one teeth number angle, the center of the recesses of the teeth of the rack gear 16 is located at the same position as the center of the recesses of the teeth of the pinion gear 17, that is, the rack gear 16 is lifted on the pinion gear 17. Accordingly, such a case is assumed, and when the residual angle θ″ is the same as the half of one teeth number angle, control is performed to stop operation and inform outside the occurrence of the state as error information, and then the control is terminated (S15).

As described above, according to the first embodiment, after the rack gear 16 is mechanically fixed, the controller 25 stores the phase difference of the pinion gear 17 in the current process detected by the encoder and controls the phase difference of the pinion gear 17 in the subsequent process based on the phase difference of the pinion gear 17 in the current process. Accordingly, the rack gear 16 and the pinion gear 17 always satisfy the positional relationship of the reference point of 0 degree, and the carrier 20 can always be carried to the vacuum processing chamber 10 in the subsequent process in the same state. Consequently, the collision between the respective tooth tops of the rack gear 16 and the pinion gear 17 due to the phase shift between the rack gear 16 and the pinion gear 17 can be avoided with a simple mechanism, and the rack gear 16 and the pinion gear 17 can be smoothly meshed with each other.

### Second Embodiment

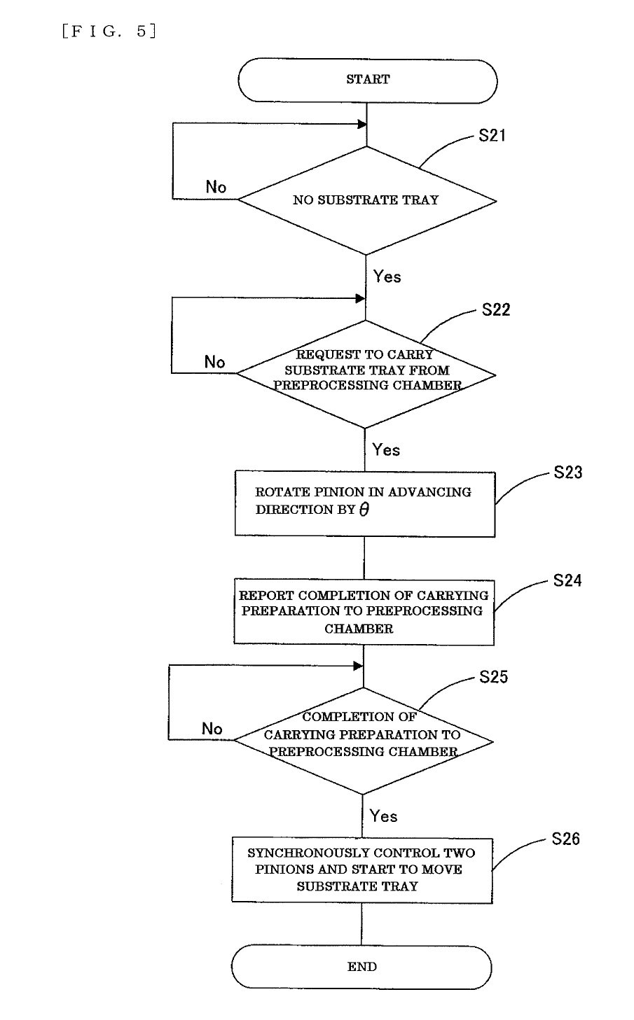

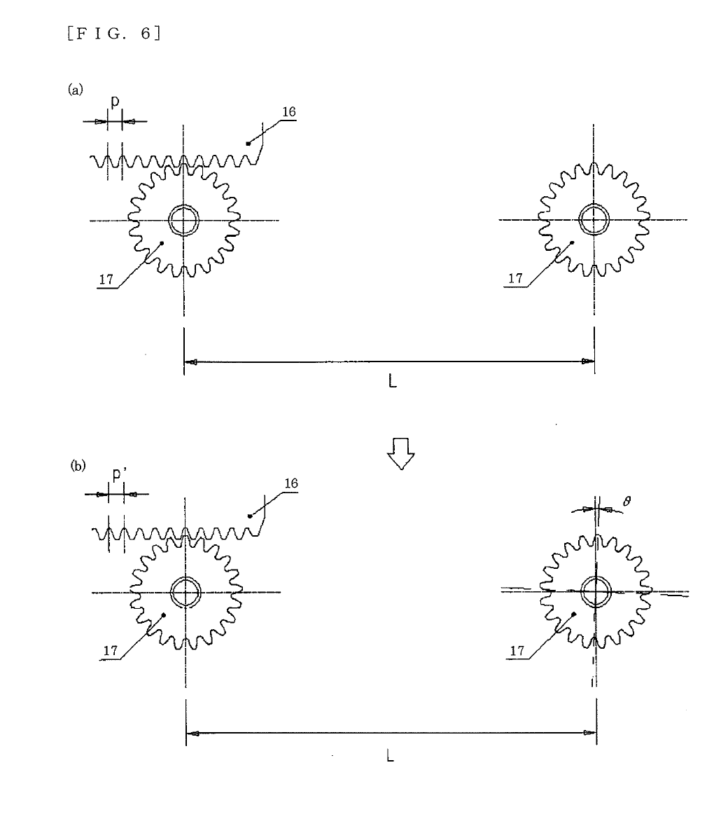

Next, a method of driving and controlling a rack and pinion mechanism of the second embodiment will be described with reference to FIGS. 5 and 6. FIG. 5 is a flow chart showing the method of driving and controlling the rack and pinion mechanism of the second embodiment. FIG. 6 is a schematic view showing a mesh relationship between a rack gear and a pinion gear of the second embodiment. Since the constitutions of the vacuum processing apparatus and the rack and pinion mechanism are common to those in the first embodiment, the description thereof will not be repeated here.

An algorithm of the method of driving and controlling the rack and pinion mechanism of the second embodiment is stored as a drive control program in a storage part 27 of a controller 25. The drive control program is read from a CPU 26 at the start of operation and then executed.

The drive control program is a program causing the controller 25 to control the rack and pinion mechanism based on a detection signal of an encoder of a servomotor 13. Specifically, the drive control program of the second embodiment has a first process of calculating the phase difference from a distance L between a pinion gear 17 in the current process and the pinion gear 17 in the subsequent process, a tooth pitch (p) of a rack gear 16, and the number of teeth of the pinion gear 17 in the subsequent process and storing the phase difference. The drive control program further has a second process of rotating the pinion gear 17 in the subsequent process in the advancing direction based on the phase difference. Further, an expansion amount calculated using a thermal expansion coefficient corresponding to an atmosphere temperature of the installation environment of the rack gear 16 is mainly added to the tooth pitch (p) of the rack gear 16 (calculation of the tooth pitch (p′) of the rack gear 16 after thermal expansion).

The drive control program is recorded in a PC-readable recording medium and installed in the storage part 27 of the PC. The recording medium includes the recording media similar to those in the first embodiment.

In the drive control method according to the second embodiment, first, whether or not the substrate trays 4a and 4b exist in the vacuum processing chamber 10 in the current process is determined (S21). When the substrate trays 4a and 4b do not exist in the vacuum processing chamber 10 in the current process (S21/Yes), the carrier 20 including the substrate trays 4a and 4b is required to be carried from a preprocessing chamber (S22).

When the carrier 20 is required to be carried (S22/Yes), a phase difference θ is calculated from the distance (L) between the pinion gear 17 in the current process and the pinion gear 17 in the subsequent process, the tooth pitch (p) of the rack gear 16, and the number of teeth of the pinion gear 17 in the subsequent process and then stored. As shown in FIGS. 6A and 6B, then, the pinion gear 17 in the subsequent process is rotated in the advancing direction by the phase difference θ (S23).

Specifically, L is obtained from “n (integer)×p”. A reminder A of L/p′ is a shift amount, and A/p′×“360 degrees÷the number of teeth of the pinion gear in the subsequent process” is the phase difference θ. The pinion gear 17 in the subsequent process is previously rotated in the advancing direction by the phase difference θ.

The controller 25 then reports the completion of carrying preparation to the preprocessing chamber (S24). When the completion of carrying preparation to the preprocessing chamber is confirmed (S25/Yes), the controller 25 synchronously controls the rotation of the respective servomotors 13 of the pinion gear 17 in the current process and the pinion gear 17 in the subsequent process and moves the substrate tray to the vacuum processing chamber 10 in the subsequent process (S26).

As described above, when the carrier 20 starts to move, the positional relationship between the rack gear 16 and the pinion gear 17 in the current process or the pinion gear 17 in the subsequent process is surely synchronized, and the same state is obtained even when the rack gear 16 meshes with the pinion gear 17 in the subsequent process. Such a series of operations is repeated in sequence, so that the collision occurring when the respective tooth tops of the rack gear 16 and the pinion gear 17 are deviated can be avoided, and thus the rack gear 16 and the pinion gear 17 can smoothly mesh with each other. Further, since a complex mechanism is not required to be provided in the vacuum processing chamber 10, adjustment and maintenance can be easily performed.

Specifically, the expansion amount calculated using the thermal expansion coefficient of the material of the rack gear 16 that corresponds to the atmosphere temperature of the installation environment in the vacuum processing chamber 10 and so on is added to the tooth pitch (p′), whereby the smooth meshing can be realized. Namely, the thermal expansion by the atmosphere temperature mainly affects the tooth pitch (p) of the rack gear 16. In the temperature measurement of the rack gear 16, for example, there is adopted such a constitution that the rack gear 16 can be observed from outside the vacuum processing chamber 10, and the temperature of the rack gear 16 is measured by a radiation thermometer (not shown). The shift amount A is calculated from the relationship among storage temperature in the storage part 27 of the controller 25, a thermal expansion coefficient, a rate of change according to movement, and so on, and the pinion gear 17 in the subsequent process is optimally adjusted.

Thus, according to the second embodiment, the collision between the respective tooth tops due to the phase shift between the rack gear 16 and the pinion gear 17 can be avoided with simple mechanism and control, and the rack gear 16 and the pinion gear 17 can be smoothly meshed with each other.

### Third Embodiment

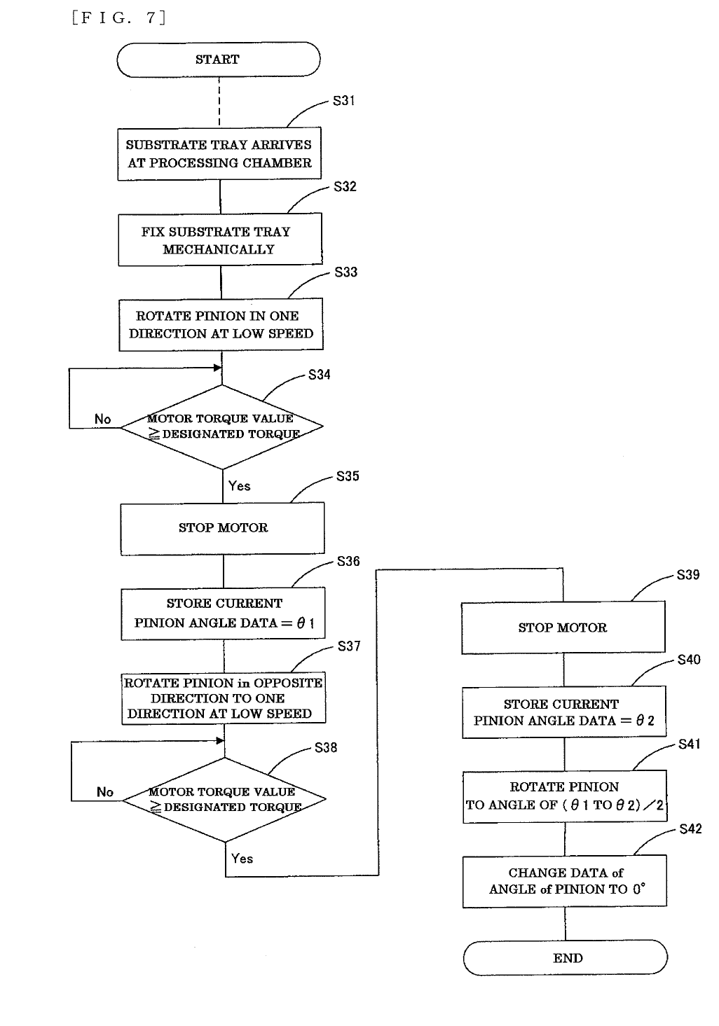

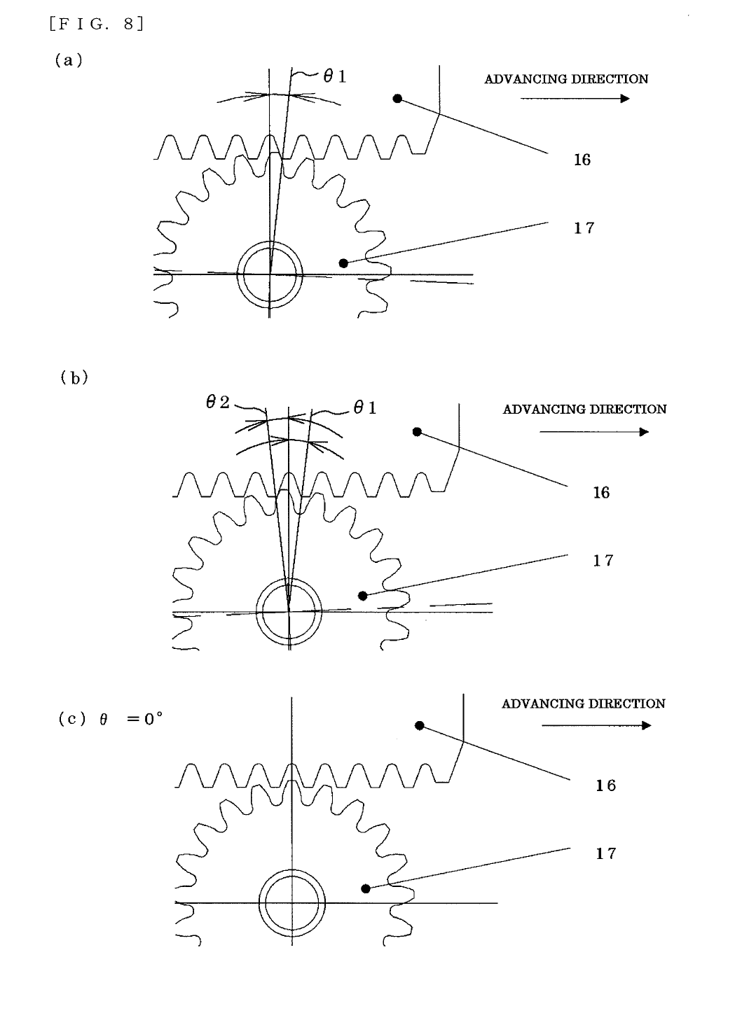

Next, a method of driving and controlling a rack and pinion mechanism of the third embodiment will be described with reference to FIGS. 7 and 8. FIG. 7 is a flow chart showing the method of driving and controlling the rack and pinion mechanism of the third embodiment. FIG. 8 is a schematic view showing a mesh relationship between a rack gear and a pinion gear of the third embodiment. Since the constitutions of the vacuum processing apparatus and the rack and pinion mechanism are common to those in the first embodiment, the description thereof will not be repeated here.

An algorithm of the method of driving and controlling the rack and pinion mechanism of the third embodiment is stored as a drive control program in a storage part 27 of a controller 25. The drive control program is read from a CPU 26 at the start of operation and then executed.

The drive control program is a program causing the controller 25 to control the rack and pinion mechanism based on a detection signal of an encoder of a servomotor 13. Specifically, the drive control program has the following processes. In the first process, the pinion gear 17 meshing with the rack gear 16 is rotated in one direction at a lower speed than a usual set carrying speed during carrying of the carrier 20. In the second process, when a torque value of the servomotor 13 is not less than a designated torque, a first phase angle of the pinion gear 17 rotated in the one direction is stored. In the third process, the pinion gear 17 is rotated in the opposite direction to the one direction at a low speed. In the fourth process, when the torque value of the servomotor 13 is not less than the designated torque, a second phase angle of the pinion gear 17 rotated in the opposite direction is stored. In the fifth process, the half angle of a rotating angle from the first phase angle to the second phase angle is calculated, and the pinion gear 17 is rotated to the half angle.

The drive control program is recorded in a PC-readable recording medium and installed in the storage part 27 of the PC. The recording medium includes the recording media similar to those in the first embodiment.

In the drive control method according to the third embodiment, when the carrier 20 comprising substrate trays 4a and 4b arrives at a vacuum processing chamber 10 (S31), the substrate trays 4a and 4b are mechanically fixed, and the position of the rack gear 16 is fixed (S32). When the position of the rack gear 16 is fixed, the carrier 20 and the rack gear are introduced into the pinion gear 17 at a lower speed than the set carrying speed.

In the above state, the pinion gear 17 meshing with the rack gear 16 is rotated to one direction (for example, the advancing direction) at an extremely low speed (S33). The low speed according to the present invention is satisfactorily lower than the usual set carrying speed and is a rotating speed large enough to, even if the teeth of the pinion gear 17 and the teeth of the rack gear 16 collide with each other, not affect the mechanical strength at all, for example, a rotating speed of not more than 1 mm/sec.

When the pinion gear 17 is continued to be rotated in one direction at a low speed, the teeth of the pinion gear 17 butt against the teeth of the rack gear 16 at a certain point as shown in FIG. 8A. As described above, since the rack gear 16 is fixed, when the teeth of the pinion gear 17 butt against the teeth of the rack gear 16, the pinion gear 17 cannot rotate after that. In such a state, if the pinion gear 17 is to be continued to be rotated, the torque value of the servomotor 13 increases, and a current value of the servomotor 13 monitored gradually increases. Accordingly, if the pinion gear 17 is continued to be rotated, an overload error of the servomotor 13 occurs finally, or the teeth are broken.

In the drive control method according to the present embodiment, the current value of the servomotor 13 monitored is taken in the controller 25 to be managed. Namely, whether or not the torque value of the servomotor 13 is not less than a designated torque is determined using the current value of the servomotor 13 (S34). At the time when the current value of the servomotor 13 is not less than the designated torque (S34/Yes), the servomotor 13 is stopped (S35). At this time, a detection signal of a first phase angle θ1 of the pinion gear 17 by an encoder is input to be stored in the storage part 27 (S36).

Further, the pinion gear 17 is rotated to the opposite direction to the one direction (for example, the opposite direction to the advancing direction) (S37), and whether or not the torque value of the servomotor 13 is not less than the designated torque is determined on the basis of the current value of the servomotor 13 as described above (S38). At the time when the current value of the servomotor 13 is not less than the designated torque (S38/Yes), the servomotor 13 is stopped (S39). Then, as shown in FIG. 8B, the encoder detects a second phase angle θ2 of the pinion gear 17 ranging from the initial position to the time of the stoppage and stores the second phase angle θ2 in the storage part 27 (S40).

As described above, the rotating angle ranging from the first phase angle θ1 to the second phase angle θ2 is a rotatable range of the pinion gear 17 generated from looseness according to the meshing state between the rack gear 16 and the pinion gear 17. It can be determined that the half angle of the rotating angle from θ1 to θ2 is the state that θ=0 degree shown in FIG. 8C. Accordingly, the pinion gear 17 is rotated by an angle of (θ1 to θ2)/2 (S41), and as shown in FIG. 8C, control is performed so that the angle of the pinion gear 17 is changed to 0 degree (S42).

During usual operation, it is preferable to control to prevent the collision between the respective teeth of the rack gear 16 and the pinion gear 17. However, when the torque value of the servomotor 13 increases, the drive control method according to the present embodiment is performed, whereby adjustment between the pinion gears can be performed by itself. Consequently, even in the reliability of a long continuous operation, the angle of the pinion gear 17 can be controlled with reliability.

As a result, according to the third embodiment, by virtue of the control by the controller 25, a complex mechanism is not required, and during the carrying of the substrates 3a and 3b, the mesh relationship between the rack gear 16 and the pinion gear 17 meshing with the rack gear 16 is adjusted by itself, so that a stable carrying can be continued. Consequently, the reliability of a long continuous operation of the rack and pinion mechanism can be improved.

Although the preferred embodiments of the present invention have been described, the invention is not limited to the above embodiments, and the invention can be variously changed within a technical range grasped from the description of the scope of claims.

### DESCRIPTION OF REFERENCE NUMERALS

100 Vacuum processing apparatus
3a, 3b Substrate
4a, 4b Substrate tray
7 Carrying track
10 Vacuum processing chamber
13 Drive source (servomotor)
15 Pinion drive device
16 Rack gear
17 Pinion gear
20 Carrier (stage)
23 Servo amplifier
24 Motor controller
25 Controller
26 CPU
27 Storage part

1. (canceled)

2. A rack and pinion mechanism, which comprises a rack gear fixed to a stage moving on a carrying track while loading a carried object thereon and a plurality of pinion gears connected to a drive source and meshing with the rack gear, wherein at least two of the pinion gears are synchronized and rotate to mesh with the rack gear in sequence, whereby the rack gear is delivered from the pinion gear in the current process to the pinion gear in the subsequent process, so that the stage is carried, the rack and pinion mechanism comprising:
detection means that detects a phase difference of the pinion gear; and
a controller which has a storage part, storing the phase difference of the pinion gear detected by the detection means, and controls the phase difference of the pinion gear in the subsequent process based on the phase difference of the pinion gear in the current process,
wherein the controller determines a reference point to the pinion gear in the current process and stores the reference point,
obtains an angle that the pinion gear in the current process rotates from the reference point from when the pinion gear starts to mesh with the rack gear till the termination of the meshing,
calculates “360 degrees÷the number of teeth of the pinion gear” as one teeth number angle of the pinion gear in the current process,
calculates a residual angle by dividing the rotating angle by the one teeth number angle,
rotates, when the residual angle is more than half of the one teeth number angle, the pinion gear in the subsequent process from the reference point in an advancing direction by “one teeth number angle−residual angle”,
and meanwhile, when the residual angle is less than the half of the one teeth number angle, rotates the pinion gear in the subsequent process from the reference point in the opposite direction to the advancing direction by the residual angle.

3. The rack and pinion mechanism according to claim 2, wherein when the residual angle is the same as the half of the one teeth number angle, the control is terminated.

4. A rack and pinion mechanism, which comprises a rack gear fixed to a stage moving on a carrying track while loading a carried object thereon and a plurality of pinion gears connected to a drive source and meshing with the rack gear, wherein at least two of the pinion gears are synchronized and rotate to mesh with the rack gear in sequence, whereby the rack gear is delivered from the pinion gear in the current process to the pinion gear in the subsequent process, so that the stage is carried, the rack and pinion mechanism comprising:
detection means that detects a phase difference of the pinion gear; and
a controller which has a storage part, storing the phase difference of the pinion gear detected by the detection means, and controls the phase difference of the pinion gear in the subsequent process based on the phase difference of the pinion gear in the current process,
wherein the controller calculates the phase difference from a distance L between the pinion gear in the current process and the pinion gear in the subsequent process, a tooth pitch p of the rack gear, and the number of teeth of the pinion gear in the subsequent process to store the phase difference in the storage part and rotates the pinion gear in the subsequent process in the advancing direction based on the phase difference.

5. The rack and pinion mechanism according to claim 4, wherein an expansion amount calculated using a thermal expansion coefficient corresponding to an atmosphere temperature of an installation environment is added to the tooth pitch p of the rack gear.

6. A vacuum processing apparatus comprising the rack and pinion mechanism according to claim 2, which carries a substrate as the carried object and is a carrying mechanism of the stage,
wherein a plurality of vacuum chambers are connected along a carrying track, and each of the vacuum chambers comprises the pinion gear.

7. A method of driving and controlling a rack and pinion mechanism, which comprises a rack gear fixed to a stage moving on a carrying track while loading a carried object thereon and a plurality of pinion gears connected to a drive source and meshing with the rack gear, wherein at least two of the pinion gears are synchronized and rotate to mesh with the rack gear in sequence, whereby the rack gear is delivered from the pinion gear in the current process to the pinion gear in the subsequent process, so that the stage is carried, the method comprising the steps of:
determining a reference point to the pinion gear in the current process and storing the reference point;
obtaining an angle that the pinion gear in the current process rotates from the reference point from when the pinion gear starts to mesh with the rack gear till the termination of the meshing;
calculating “360 degrees÷the number of teeth of the pinion gear” as one teeth number angle of the pinion gear in the current process;
calculating a residual angle by dividing the rotating angle by the one teeth number angle;
when the residual angle is more than half of the one teeth number angle, rotating the pinion gear in the subsequent process from the reference point in an advancing direction by “one teeth number angle−residual angle”; and
meanwhile, when the residual angle is less than the half of the one teeth number angle, rotating the pinion gear in the subsequent process from the reference point in the opposite direction to the advancing direction by the residual angle.

8. The method of driving and controlling a rack and pinion mechanism according to claim 7, wherein when the residual angle is the same as the half of the one teeth number angle, the control is terminated.

9. A method of driving and controlling a rack and pinion mechanism, which comprises a rack gear fixed to a stage moving on a carrying track while loading a carried object thereon and a plurality of pinion gears connected to a drive source and meshing with the rack gear, wherein at least two of the pinion gears are synchronized and rotate to mesh with the rack gear in sequence, whereby the rack gear is delivered from the pinion gear in the current process to the pinion gear in the subsequent process, so that the stage is carried, the method comprising the steps of:
calculating a phase difference from a distance L between the pinion gear in the current process and the pinion gear in the subsequent process, a tooth pitch p of the rack gear, and the number of teeth of the pinion gear in the subsequent process and storing the phase difference; and
rotating the pinion gear in the subsequent process in the advancing direction based on the phase difference.

10. The method of driving and controlling a rack and pinion mechanism according to claim 9, wherein an expansion amount calculated on the basis of a thermal expansion coefficient corresponding to an atmosphere temperature of an installation environment is added to the tooth pitch p of the rack gear.

11. A computer readable recording medium recorded with the drive control program of a rack and pinion mechanism, which comprises a rack gear fixed to a stage moving on a carrying track while loading a carried object thereon and a plurality of pinion gears connected to a drive source and meshing with the rack gear, wherein at least two of the pinion gears are synchronized and rotate to mesh with the rack gear in sequence, whereby the rack gear is delivered from the pinion gear in the current process to the pinion gear in the subsequent process, so that the stage is carried, the program being characterized by causing a controller, which controls the rack and pinion mechanism, to execute the steps of:
determining a reference point to the pinion gear in the current process and storing the reference point;
obtaining an angle that the pinion gear in the current process rotates from the reference point from when the pinion gear starts to mesh with the rack gear till the termination of the meshing;
calculating “360 degrees÷the number of teeth of the pinion gear” as one teeth number angle of the pinion gear in the current process;
calculating a residual angle by dividing the rotating angle by the one teeth number angle;
when the residual angle is more than half of the one teeth number angle, rotating the pinion gear in the subsequent process from the reference point in an advancing direction by “one teeth number angle−residual angle”; and
meanwhile, when the residual angle is less than the half of the one teeth number angle, rotating the pinion gear in the subsequent process from the reference point in the opposite direction to the advancing direction by the residual angle.

12. The computer readable recording medium according to claim 11, wherein when the residual angle is the same as the half of the one teeth number angle, the control is terminated.

13. A computer readable recording medium recorded with the drive control program of a rack and pinion mechanism, which comprises a rack gear fixed to a stage moving on a carrying track while loading a carried object thereon and a plurality of pinion gears connected to a drive source and meshing with the rack gear, wherein at least two of the pinion gears are synchronized and rotate to mesh with the rack gear in sequence, whereby the rack gear is delivered from the pinion gear in the current process to the pinion gear in the subsequent process, so that the stage is carried, the program being characterized by causing a controller, which controls the rack and pinion mechanism, to execute the steps of:
calculating a phase difference from a distance L between the pinion gear in the current process and the pinion gear in the subsequent process, a tooth pitch p of the rack gear, and the number of teeth of the pinion gear in the subsequent process and storing the phase difference; and
rotating the pinion gear in the subsequent process in the advancing direction based on the phase difference.

14. The computer readable recording medium according to claim 13, wherein an expansion amount calculated using a thermal expansion coefficient corresponding to an atmosphere temperature of an installation environment is added to the tooth pitch p of the rack gear.

15. (canceled)

16. A rack and pinion mechanism comprising:
a rack gear which is fixed to a stage moving on a carrying track while loading a carried object thereon;
a plurality of pinion gears which are connected to a drive source and mesh with the rack gear in sequence to move the stage;
detection means that detects a phase angle of the pinion gear; and
a controller which has a storage part storing the phase angle of the pinion gear detected by the detection means,
wherein the controller controls the drive source during carrying of the stage, rotates the pinion gear, meshing with the rack gear, in one direction at a lower speed than a set carrying speed, stores, when a torque value of the drive source is not less than a designated torque, a first phase angle of the pinion gear rotated in the one direction that is detected by the detection means,
stores, when the pinion gear is rotated in the opposite direction to the one direction at the low speed, and the torque value of the drive source is not less than a designated torque, a second phase angle of the pinion gear rotated in the opposite direction that is detected by the detection means,
and calculates the half angle of a rotating angle from the first phase angle to the second phase angle and rotates the pinion gear to the half angle.

17. The rack and pinion mechanism according to claim 16, wherein the rack gear is introduced into the pinion gear at a lower speed than the set carrying speed, the rack gear is fixed, and control is performed by the controller.

18. A vacuum processing apparatus comprising the rack and pinion mechanism according to claim 16, which carries a substrate as the carried object and is a carrying mechanism of the stage,
wherein a plurality of vacuum chambers are connected along the carrying track, and each of the vacuum chambers comprises the pinion gear.

19. A method of driving and controlling a rack and pinion mechanism, which comprises a rack gear fixed to a stage moving on a carrying track while loading a carried object thereon and a plurality of pinion gears connected to a drive source and meshing with the rack gear in sequence to move the stage, the method comprising the steps of:
during carrying of the stage, rotating the pinion gear meshing with the rack gear in one direction at a lower speed than a set carrying speed;
when a torque value of the drive source is not less than a designated torque, storing a first phase angle of the pinion gear rotated in the one direction;
rotating the pinion gear in the opposite direction to the one direction at the low speed;
when the torque value of the drive source is not less than the designated torque, storing a second phase angle of the pinion gear rotated in the opposite direction; and
calculating the half angle of a rotating angle from the first phase angle to the second phase angle and rotating the pinion gear to the half angle.

20. The method of driving and controlling a rack and pinion mechanism according to claim 19, wherein the rack gear is introduced into the pinion gear at a lower speed than the set carrying speed, the rack gear is fixed, and control is performed.

21. A computer readable recording medium recorded with the drive control program of a rack and pinion mechanism, which comprises a rack gear fixed to a stage moving on a carrying track while loading a carried object thereon and a plurality of pinion gears connected to a drive source and meshing with the rack gear in sequence to move the stage, the program causing a controller, which controls the rack and pinion mechanism, to execute the steps of:
during carrying of the stage, rotating the pinion gear meshing with the rack gear in one direction at a lower speed than a set carrying speed;
when a torque value of the drive source is not less than a designated torque, storing a first phase angle of the pinion gear rotated in the one direction;
rotating the pinion gear in the opposite direction to the one direction at the low speed;
when the torque value of the drive source is not less than the designated torque, storing a second phase angle of the pinion gear rotated in the opposite direction; and
calculating the half angle of a rotating angle from the first phase angle to the second phase angle and rotating the pinion gear to the half angle.

22. (canceled)

23. A vacuum processing apparatus comprising the rack and pinion mechanism according to claim 4, which carries a substrate as the carried object and is a carrying mechanism of the stage,
wherein a plurality of vacuum chambers are connected along a carrying track, and each of the vacuum chambers comprises the pinion gear.
